(19) United States
(12) Patent Application Publication
(10) Pub. No.: US 2022/0343793 A1
(43) Pub. Date: Oct. 27, 2022

(54) System and Method for Providing Black History Educational Content

(71) Applicants: Gloria Roberts, Chicago, IL (US); Michael Roberts, Chicago, IL (US)

(72) Inventors: Gloria Roberts, Chicago, IL (US); Michael Roberts, Chicago, IL (US)

(21) Appl. No.: 17/724,681

(22) Filed: Apr. 20, 2022

Related U.S. Application Data
(60) Provisional application No. 63/178,249, filed on Apr. 22, 2021.

(51) Int. Cl. G09B 19/00; G09B 7/00; G06F 16/9535

(52) U.S. Cl. CPC G09B 19/0046; G09B 7/00; G06F 16/9535

(57) ABSTRACT

The present invention relates to a system and method using a computer implemented application and a website for educating individuals about contributions and positive impact of black culture. The system includes a server with associated databases for storing black history content and providing access to users via the application and the website. The system provides games and quizzes about black history which are played by users for learning and also receiving certificates, coupons, and worksheets. The system provides all the black history resources to users and enables individuals to improve their knowledge of black history.

### CROSS-REFERENCE TO RELATED APPLICATION

The present application claims priority to, and the benefit of, U.S. Provisional Application No. 63/178,249 which was filed on Apr. 22, 2021 and is incorporated herein by reference in its entirety.

### FIELD OF THE INVENTION

The present invention relates generally to the field of learning systems and methods. More specifically, the present invention relates to a system, a method and an associated computer implemented application for educating individuals about important people and events in black history. The invention provides black history content, quizzes, and games based on the content along with rewards and certificates enabling people to improve their knowledge of black history. Accordingly, the present disclosure makes specific reference thereto. Nonetheless, it is to be appreciated that aspects of the present invention are also equally applicable to other like applications, devices, and methods of manufacture.

### BACKGROUND

By way of background, contributions of black people have been immense in the growth of mankind, technology, art, literature, science and more. However, individuals have a lack of information about the contribution of black people. Black history month has been celebrated every year in February since 1976 for recognizing the contributions of African Americans to U.S. history. However, during the rest of the year individuals forget about the contributions and focus more on the negatives of black culture and thereby remain unaware about contributions of African Americans to the United States. There is a desire in black people to educate people about black history and the contributions made to the United States.

There are limited resources about black history and the resources are not easily accessible to users. With the advent of internet, black people desire a system that can provide to them all the black history resources at a single place with ease such that data is accessible on their smartphones and computing devices.

Therefore, there exists a long-felt need in the art for a system and method that educates individuals about important people and events in black history. There is also a long-felt need in the art for a method that enables individuals to learn about black history in an interactive manner. Additionally, there is a long-felt need in the system that provides contributions and describes positive impacts of black people at a single place. Moreover, there is a long-felt need in the art for a system that creates awareness in individuals about the contribution of black culture in United States. Further, there is a long-felt need in the art for a system that allows individuals to learn about black culture easily on their smartphones and computing devices. Finally, there is a long-felt need in the art for a system and method that provides knowledge and helps in improving awareness of important black historical figures, such as, poets, musicians, inventors, pioneers, and more.

The subject matter disclosed and claimed herein, in one embodiment thereof, comprises a computer implemented system for educating individuals about contributions of black culture. The system has a client-server architecture wherein the users access information from the server. The system includes at least one processor in a server, a non-transitory computer-readable storage medium comprising instructions, that when executed, controls the one or more computer processors to be configured for presenting one or more graphical user interfaces for a learner, the graphical user interfaces include black history content, quizzes, meetings, and games wherein the games and quizzes are related to black history; recommending new black history content based on learner's performance in the quizzes and games; and, generating digital certificates for the learner upon winning quizzes and games.

In this manner, the black history computer implemented system and associated method of the present invention accomplishes all of the foregoing objectives and provides a system that educates individuals about important people and events in black history using a software application and website. The system allows users to participate in games, quizzes, and viewing of narrated stories of black history and black historical figures.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a method for educating users about important people and events in black history. The method includes the steps of receiving, by a server, selections of one or more black persons or events related to a black person from a user; transmitting, by the server, videos and other content related to the selected black person or event to a computer implemented software application; displaying, by the application, the received information; determining, by the server, watch history and preferences of the user; determining, by the server, new black history content for display to the user wherein the new black history content includes black history quizzes and games to be played by the user either alone or with other users.

In yet another embodiment, the method further includes the step of generating a certificate for a user winning a quiz or a game.

In yet another embodiment, a computer implemented method for presenting black history data for learners is described. The method comprising the steps of presenting, by a processor, a plurality of graphical user interfaces that include black history content in the form of videos, images, virtual meetings and more; receiving, by the processor, a request for a quiz and a game from a learner; generating, by the processor, a quiz and a game including black history content; recommending, by the processor, new black history content based on the performance of the learner in the quiz and the game.

In yet another embodiment, a non-transitory computer readable storage medium storing one or more programs, the programs comprising the instructions for presenting one or more graphical user interfaces for a learner, the graphical user interfaces include black history content, quizzes, meetings, and games wherein the games and quizzes are related to black history; recommending new black history content based on learner's performance in the quizzes and games; and, generating a digital certificate for the learner upon winning quizzes and games.

In yet another embodiment, a computer implemented system is disclosed. The system includes at least one processor in a server, a non-transitory computer-readable storage medium comprising instructions, that when executed, control the one or more computer processors to be configured for presenting one or more graphical user interfaces for a learner, the graphical user interfaces include black history content, quizzes, meetings, and games wherein the games and quizzes are related to black history; recommending new black history content based on learner's performance in the quizzes and games; and, generating digital certificates for the learner upon winning quizzes and games.

In yet another embodiment, the server is a cloud server system.

In yet another embodiment, the server is a distributed server system.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of one potential embodiment of the black history awareness and learning system of the present invention in accordance with the disclosed architecture;

FIG. 2 illustrates a block diagram view of the exemplary server used in the black history learning system of the present invention in accordance with the disclosed architecture;

FIG. 3 illustrates an exemplary user interface of the black history learning application or website in accordance with the disclosed architecture;

FIG. 4 illustrates another graphical user interface of the black history learning application/website for enabling users to add ‘favorites’ in accordance with the disclosed architecture;

FIG. 5 illustrates yet another graphical user interface displayed by the application/website for enabling a user to select and play a black history educational game in accordance with the disclosed architecture;

FIG. 6 illustrates a flow diagram depicting a process of playing games and quizzes in the black history software application and website for learning black history in accordance with the disclosed architecture;

FIG. 7 illustrates a flow diagram depicting a process of recommending new quizzes, games and educational content to a user by the system of the present invention in accordance with the disclosed architecture;

FIG. 8 illustrates another user interface displayed by the black history learning software application/website for creating and/or attending virtual live events for creating programs on black history in accordance with the disclosed architecture;

FIG. 9 illustrates a functional block diagram showing different types of membership plans offered by the system of the present invention for users in accordance with the disclosed architecture; and

FIG. 10 illustrates an exemplary user device that is used for installing the black history learning software application of the present invention for communication with the server in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system and method that educates individuals about important people and events in black history. There is also a long-felt need in the art for a method that enables individuals to learn about black history in an interactive manner. Additionally, there is a long-felt need in the system that provides contributions and describes positive impacts of black people at a single place. Moreover, there is a long-felt need in the art for a system that creates awareness in individuals about the contribution of black culture in the United States. Further, there is a long-felt need in the art for a system that allows individuals to learn about black culture easily on their smartphones and computing devices. Finally, there is a long-felt need in the art for a system and method that provides knowledge and helps improve awareness of important black historical figures, such as, poets, musicians, inventors, pioneers, and more.

The present invention, in one exemplary embodiment, is a novel method for educating users about important people and events in black history. The method includes the steps of receiving, by a server, a selection of one or more black persons or events related to a black person from a user; transmitting, by the server, videos and other content related to the selected black person or event to a computer implemented software application; displaying, by the application, the received information; determining, by the server, watch history and preferences of the user; and, determining, by the server, new black history content for display to the user wherein the new black history content includes black history quizzes and games to be played by the user either alone or with other users.

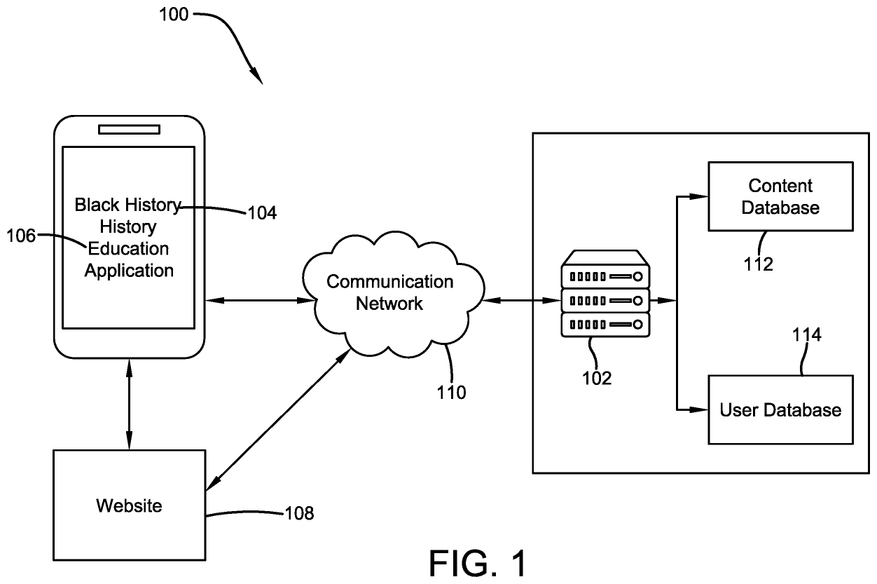

Referring initially to the drawings, FIG. 1 illustrates a schematic view of one potential embodiment of the black history awareness and learning system of the present invention in accordance with the disclosed architecture. The black history awareness and learning system 100 of the present invention is designed to provide users a software application and/or a website for educating about important people and events in black history. The system 100 is configured to create awareness about black history by providing resources and information in an easy to access manner. The system 100 allows people to play games, take quizzes, watch videos, and more about black history to learn in a fun and interactive manner.

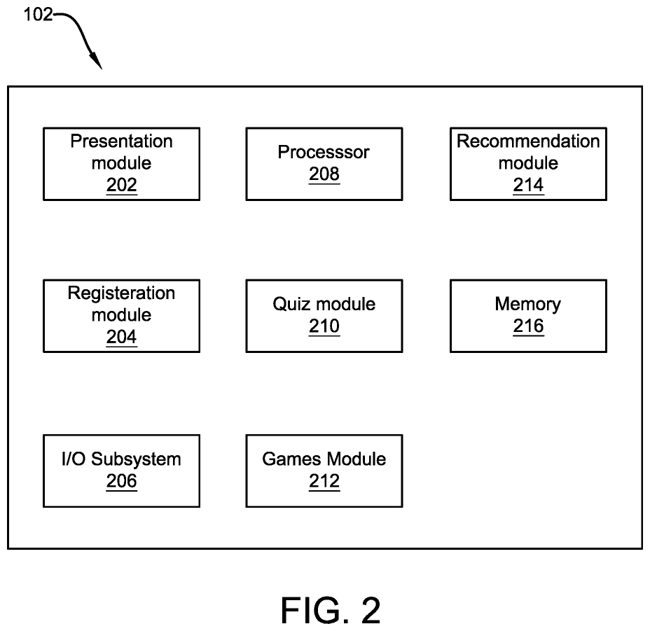

More specifically, the system 100 includes a computer implemented server 102 which can be in the form of a central server, cloud-based server, or distributed server. The server 102 is configured to provide a plurality of graphical user interfaces (GUI) on the application/website accessed by users through their electronic devices. Details of the server 102 are described in FIG. 2. The server 102 can be realized through various web-based technologies such as, but not limited to, a Java web-framework, a .NET framework, a personal home page (PHP) framework, or any web-application framework. The server 102 may be maintained by a storage facility management authority or a third-party entity that facilitates service enablement and resource allocation operations of the system 100.

The system 100 provides access to educational content through a black history learning software application 104 accessible on an electronic device 106. The application 104 includes computer readable instructions readable by the processor of the electronic device 106. The electronic device 106 can be a smartphone, laptop, PDA, smartwatch, or any other conventional computing system and is used for interacting with the server 102, thereby enabling users to access functionalities provided by the server 102.

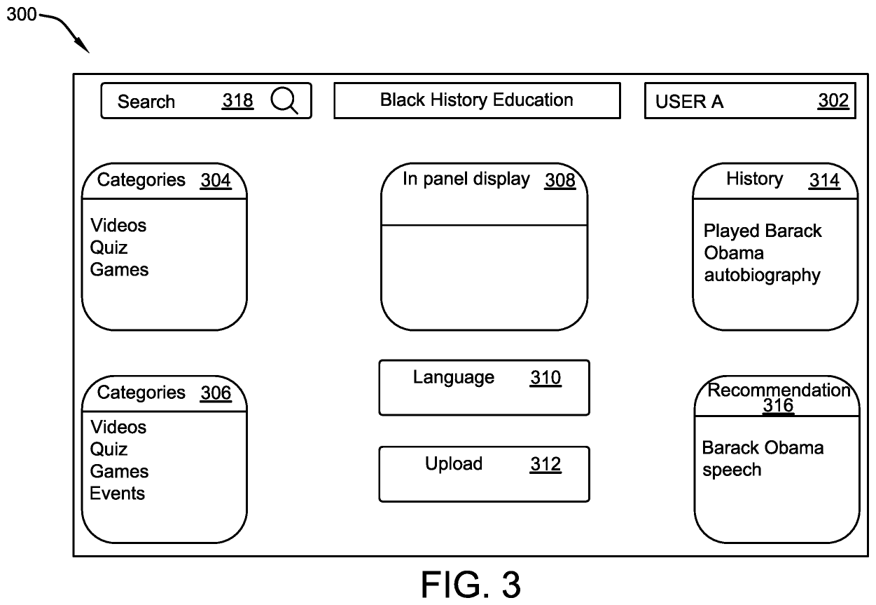

Similar to the application 104, a website 108 provided by the server 102 provides access to the functionalities and content provided by the server 102. The GUIs on both the application 104 and the website 108 are similar and are scaled and formatted to fit within the display of the devices. The application/website accessible to users is configured to provide different GUIs as illustrated in FIGS. 3-5 and FIG. 8 to a user when logged into the application/web site.

A communication network 110 such as the internet is used for communication between the mobile application 104, website 108, and the server 102. The communication network 110 may include a wireless channel, a wired channel, or a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the internet, a fiber optic network, a coaxial cable network, an infrared (IR) network, a radio frequency (RF) network, and a combination thereof. Embodiments of the present invention are intended to include or otherwise cover any type of communication channel, including known, related art, and/or later developed technologies.

The server 102 is associated with a content database 112 used for securely storing all black history content in various formats. The content can be in the form of files, documents, videos, any other type of media and more and is accessible to users for learning. A user, upon logging into the system, accesses the stored content in a format suitable for display of their electronic device. A user database 114 securely stores information of registered users of the system 100. The information may include, but is not limited to name, location, age, gender, profession and more. The black history education system 100 is designed to provide all resources and information of black history to users and thus create awareness of same.

FIG. 2 illustrates a block diagram view of the exemplary server 102 used in the black history learning system 100 of the present invention in accordance with the disclosed architecture. The server 102 is configured to provide portions, or all, of the GUIs that have features enabling users to learn about black history. The server 102 may be configured to perform one or more operations, methods, etc. described herein that enable black history learning for users. The server 102 may be configured to provide games, quizzes, and/or educational information in the form of videos and more to users through the black history learning application and website.

The server 102 can be a network of computers, a software framework, or a combination thereof, that may provide a generalized approach to create the server implementation. The server 102 has a presentation module 202 configured to generate a plurality of GUIs. The GUIs provide features to users for enabling them to learn educational content, play games, take quizzes, interact with other users and more.

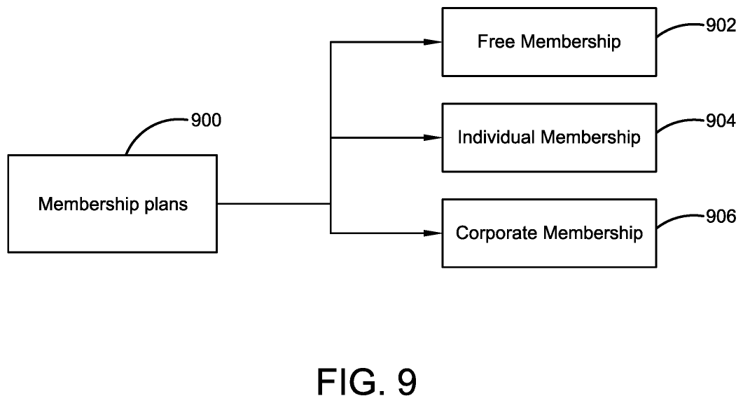

A registration module 204 is configured to manage registration of users, manage and control the login process of registered users enabling a secure environment for users without compromising their personal information. Further, the module 204 helps in making the educational content accessible based on the subscription plan (shown in FIG. 9). More specifically, the registration module 204 allows a user to complete the user registration process and receive security credentials in the form of a username and password.

An input/output (I/O) subsystem 206 allows the server 102 to communicate to one or more electronic devices and one or more databases. The I/O subsystem 206 can be in the form of ports and wireless modules enabling the server 102 to communicate using both wired and wireless medium. The I/O subsystem 206 can also be circuitry and/or components to facilitate input/output operations with the processor 208 and/or other components of the server 102.

The processor 208 may be any type of processor or combination of processors capable of executing software/firmware, such as a one or more microprocessors, digital signal processors, microcontrollers, or the like. The processor 208 may be a single processor or may include multiple processors. The processor 208 is communicatively coupled to the I/O subsystem 206.

A quiz module 210 is configured to generate quizzes using the content stored in the content database of the system 100. The quiz module 210 may generate quizzes that are pre-stored in the memory 216 of the server 102. Questions for the quizzes may also be selected in real time from a dynamic pool of questions.

A games module 212 is configured to generate both passive and interactive games using the content stored in the content database of the system 100. The games may be associated with rewards enabling users to participate and win prizes.

A recommendation module 214 uses machine learning and artificial intelligence to learn interactions of users with the system 100. The recommendation module 214 retrieves the content/information accessed by users for providing recommendation on new data in addition to recommending other users having similar interests. The recommendation module 214 is configured to make the system and learning personalized and interactive.

The memory 216 may include one or more volatile and/or non-volatile memory devices. The memory 216 is communicatively coupled to the I/O subsystem 206 via a number of signal paths. Various data and software may be stored in the memory 216. Any type of devices configured for short-term or long-term storage of data, such as, for example, memory devices and circuits, memory cards, hard disk drives, solid-state drives, or other data storage devices can be used as memory 216.

FIG. 3 illustrates an exemplary user interface of the black history learning application or website in accordance with the disclosed architecture. As illustrated, the user interface 300 displays customized information for the logged in user 302 “User A”. The interface 300 displays a categories tab 304 configured to list various types of offerings provided by the system 100. As illustrated, educational videos, quizzes, and games are exemplary included in the categories tab 304. The user can select any of the categories to view the associated content. For example, a user can select the quiz tab for playing a quiz to check knowledge of black history in a specific topic.

A plurality of pre-defined topics 306 including exemplary topics like Education, Music, Science, Literature, and more are displayed by the interface 300. Any of the topics can be selected by the user 302 for displaying relevant black history content corresponding to the topic. It should be noted that the system 100 can automatically update the topic list based on the content stored in the database. An in-panel display 308 displays the content in an appropriate format. The length and width of the display 308 can be adjusted automatically to conveniently display the content.

A preferred language can be set for the content using the language tab 310. The system offers content in a plurality of languages including, but not limited to, English, Spanish, African, German, and more. The system 100 of the present invention provides the capability to a user to upload relevant black history content using the upload button 312. The uploaded content is verified by an administration team (not shown) of the system 100 and once verified, can be added to the system 100 as educational content.

History 314 includes the user accessed content enabling a user to revisit the content as per preferences of the user. The history 314 is also used by the recommendation engine of the system to recommend 316 new educational content to the user 302 based on the preferences and tastes of the user. Any of the content available in the system 100 can be searched by the user using the search tab 318. The relevant hits are displayed on the interface 300 enabling users to easily select any of the educational content for learning.

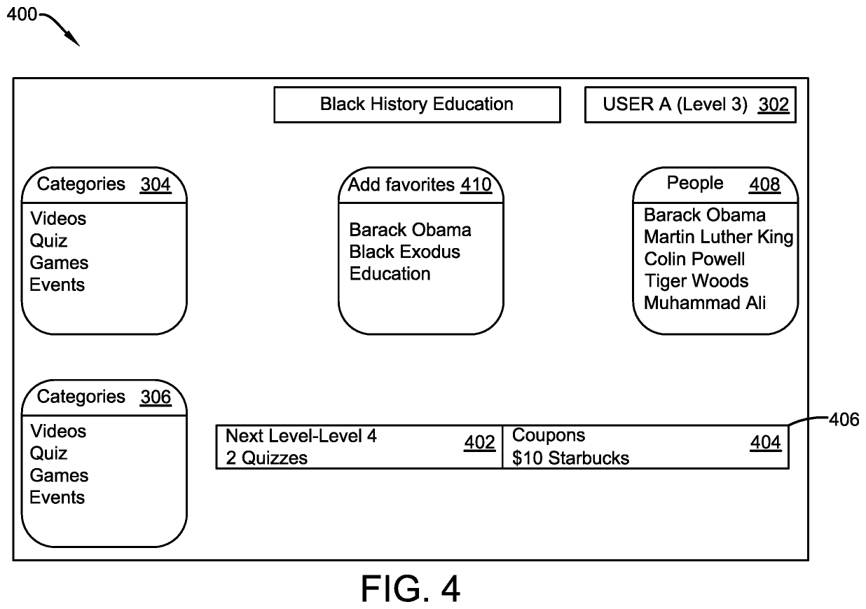

FIG. 4 illustrates another graphical user interface of the black history learning application/website for enabling users to add ‘favorites’ in accordance with the disclosed architecture. The system 100 provides a plurality of levels that can be achieved by users through learning educational content, winning games, and/or completing quizzes. As illustrated, the user 302 is at Level 3 and the next level that can be achieved by the user 302 is Level 4 which can be achieved by completing two quizzes as displayed in the section 402. The rewards 404 won by the user 302 are also displayed in the reward section 406 enabling the user to redeem the rewards/coupons as per the preferences of the user.

The interface 400 allows the user 302 to select one or more topics from the topic section 306, one or more categories from categories section 304, and/or one or more important black people from people section 408 to add to the favorites section 410. The user 302 has added, as an example, Barack Obama, Black Exodus and Education to the favorites section 410 that allows easy access of these subjects and related information.

The favorites added by a user are also used by the recommendation engine of the system 100 to recommend more similar content, people, and events, thereby providing a more personalized learning environment to the users.

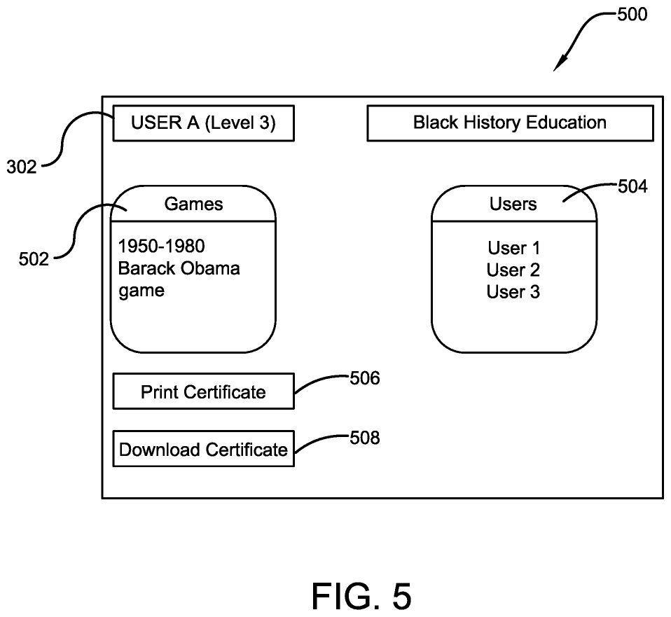

FIG. 5 illustrates yet another graphical user interface displayed by the application/website for enabling a user to select and play a black history educational game in accordance with the disclosed architecture. As illustrated, the user interface 500 displays a plurality of games in the games section 502. As examples, 1950-1980 and Barack Obama games are displayed in the games section 502. A plurality of users like User 1-3 are displayed in the users section 504 that are available for playing a one-on-one game with the logged in user 302. After selection of the game and a user, the game can be initiated on the interface 500.

A certificate for a winner of the game is also available for printing using the print certificate tab 506 and also the certificate can be downloaded using the download certificate section 508.

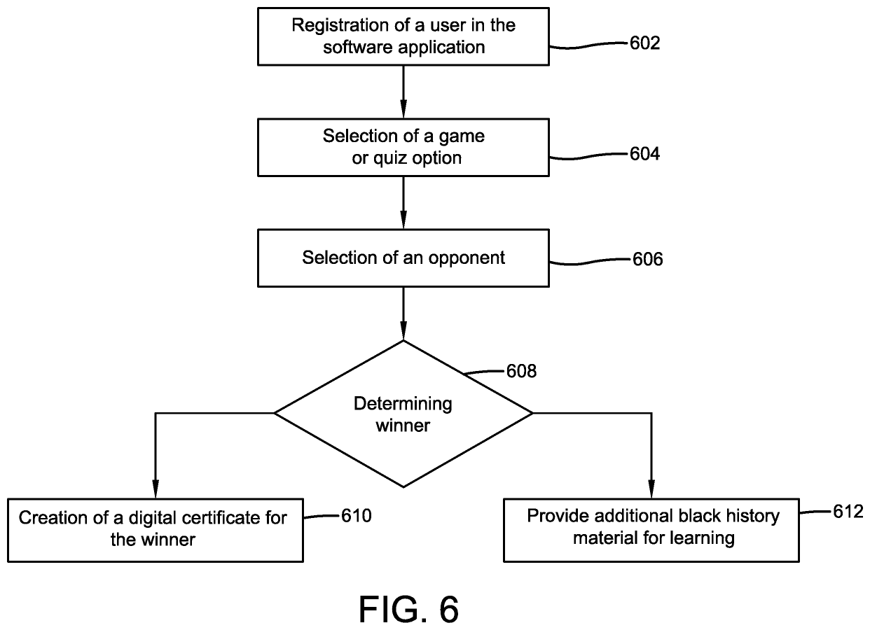

FIG. 6 illustrates a flow diagram depicting a process of playing games and taking quizzes in the black history software application and website for learning black history in accordance with the disclosed architecture. Initially, a user is registered and login to the system (Step 602). Thereafter, a black history quiz and/or a game is selected by the user (Step 604) and an opponent i.e., a different user logged into the system and available for playing game/quiz is selected (Step 606). Once, the user accepts the invite and the game/quiz is played, a winner is determined between the users (Step 608). The system then creates a digital certificate to the winner (Step 610) and the certificate may have the name of the winner. The system also provides additional black history educational material to the user who loses the game/quiz (Step 612).

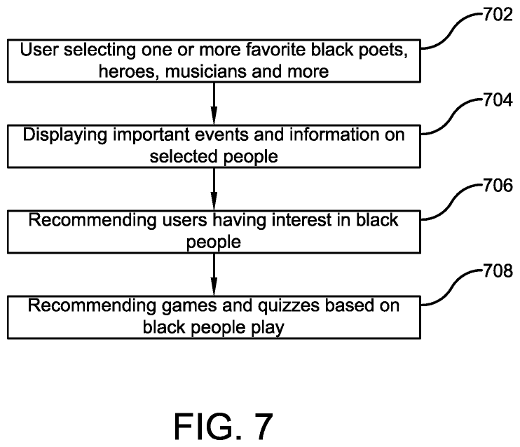

FIG. 7 illustrates a flow diagram depicting a process of recommending new quizzes, games, and educational content to a user by the system 100 of the present invention in accordance with the disclosed architecture. Initially, a user of the system 100 accessing the system using the software application/web site selects one or more favorite black poets, heroes, musicians and more (Step 702). Of the selected people, important information, dates, events, and more are displayed to the user for learning and awareness (Step 704). Using the recommendation engine of the system, other users of the system are recommended to the user for making connections to play games and take quizzes (Step 706). Based on the interaction of the user with the system 100, the recommendation engine recommends games and quizzes along with new educational content to the user for learning (Step 708).

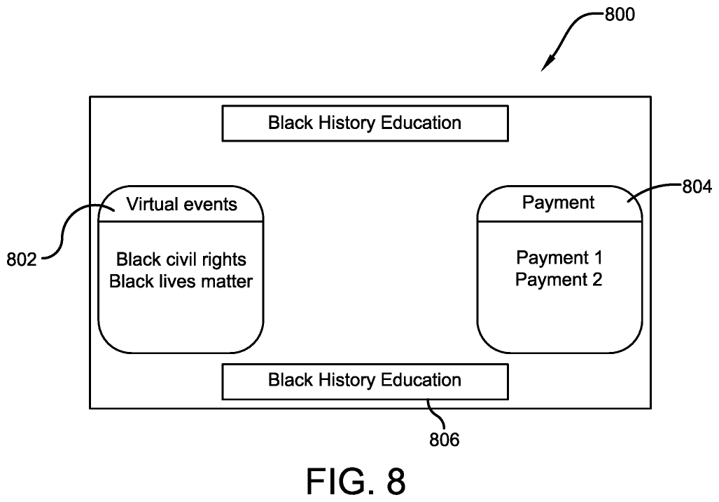

FIG. 8 illustrates another user interface 800 displayed by the black history learning software application/web site for creating and/or attending virtual live events for creating programs on black history in accordance with the disclosed architecture. The present invention allows users to attend virtual events and create virtual events for creating black history awareness. As illustrated, planned virtual events are listed under the virtual event section 802 and can be selected by a user to join at the specified time. In case the event is a paid event, then, any of the payment methods listed under the payment section 804 can be used by users. The payment methods are added by users as per their preferences.

For creating a new event, the user uses the create event tab 806 and the created event can be broadcasted or selectively shared with selected users of the system.

FIG. 9 illustrates a functional block diagram showing different types of membership plans offered by the system 100 of the present invention for users in accordance with the disclosed architecture. A membership plan 900 can be purchased by a user to access the paid content offered by the system and can be used for learning more about black history. More specifically, a free membership 902 provides basic and free content to users. Paid content from the creators is not available in free membership 902.

Individual membership 904 is a paid membership that provides access to premium content. The membership 904 can be purchased by an individual and can be cancelled at any time. A corporate membership 906 is a bulk membership that can be purchased by schools, colleges, organizations and more to impart black history knowledge to their students, employees and more.

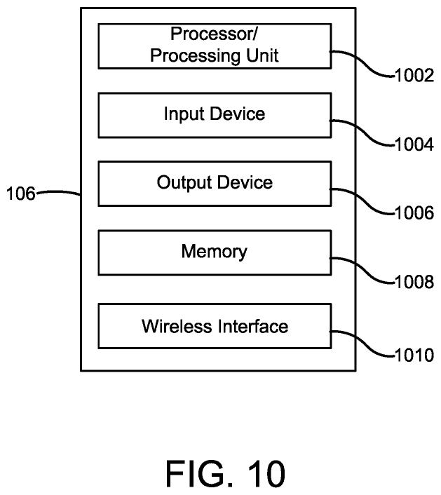

FIG. 10 illustrates an exemplary user device 106 that is used for installing the black history learning software application 104 of the present invention for communication with the server in accordance with the disclosed architecture. The processing unit 1002 may include suitable logic, instructions, circuitry, interfaces, and/or codes for executing various operations, such as the operations associated with the user device 106, or the like. The processing unit 1002 may be configured to control one or more operations executed by the user device 106 in response to the input received at the user device 106 from the user. The processor 1002 executes the computer readable instructions stored in the application 104. Examples of the processing unit 1002 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 1002 including known, related art, and/or later developed processing units. The user device 106 can further include one or more computer executable applications configured to be executed by the processing unit 1002. The one or more computer executable applications may include suitable logic, instructions, and/or codes for executing various operations. The one or more computer executable applications may be stored in the memory 1008. The one or more computer executable applications can include the fit match application.

The user device 106 includes input device(s) 1004 such as a touch input device, voice input device, etc. for entering data and information. Preferably, the touch interface of the user device 106 is used as the input and various buttons/tabs shown on the application 104 are pressed or clicked by the user. Other input devices such as cameras and microphones are used during video chatting by the user. The display of the user device 106 also acts as the output device 1006 for displaying various contents (i.e., text, images, videos, icons, and/or symbols, etc.) to the user. The display can include a touch screen, and may receive, for example, a touch, gesture, proximity, or hovering input using an electronic pen or a part of a user's body.

Electronic device 106 has memory 1008 used for storing programs (sequences of instructions) or data (e.g., program state information) on a temporary or permanent basis for use in the computer system. Memory 1008 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The processor 1002, in combination with one or more of memory 1008, input device(s) 1004, output device(s) 1006, is utilized to provide users to execute instructions on the application 104. The connection to a network is provided by wireless interface 1010.

The wireless interface 1010 enables the user device 106 to communicate with the server 102 and other components of the system 100 over the communication network 110, according to embodiments of the present disclosure. Examples of the communication interface 1010 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface 1010 may include any device and/or apparatus capable of providing wireless or wired communications between the user device 106 and the server 102.

As used herein, the term “server” refers to any computerized component, system, or entity regardless of form which is adapted to provide data, files, applications, content, or other services to one or more other devices or entities on a computer network.

As used herein, the term “user interface” or “graphical user interface” refers to, without limitation, any visual, graphical, tactile, audible, sensory, or other means of providing information to and/or receiving information from a user or other entity.

Embodiments of the present disclosure take the form of computer-executable instructions, including algorithms executed by a programmable computer. However, the disclosure can be practiced with other computer system configurations as well. Certain aspects of the disclosure can be embodied in a special-purpose computer or data processor that is specifically programmed, configured, or constructed to perform one or more of the computer-executable algorithms described below. Accordingly, the term “computer” as generally used herein refers to any data processor and includes internet appliances, hand-held devices (including tablets, computers, wearable computers, cellular or mobile phones, multi-processor systems, processor-based or programmable consumer electronics, network computers, minicomputers) and the like.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “system”, “black history learning system”, “black history system”, and “system” are interchangeable and refer to the black history learning system 100 of the present invention. Similarly, as used herein “software application”, “black history learning application”, and “application” are interchangeable and refer to the black history learning software application 104 of the present invention.

Notwithstanding the foregoing, the black history learning system 100 and the black history learning software application 104 of the present invention can be of any suitable size and configuration as is known in the art without affecting the overall concept of the invention, provided that it accomplishes the above-stated objectives. One of ordinary skill in the art will appreciate that the black history learning system 100 and the black history learning software application 104 as shown in the FIGS. are for illustrative purposes only, and that many other sizes and shapes of the black history learning system 100 and the black history learning software application 104 are well within the scope of the present disclosure. Although the dimensions of the black history learning system 100 and the black history learning software application 104 are important design parameters for user convenience, the black history learning system 100 and the black history learning software application 104 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for providing access to educational content through a black history learning software application, the system comprising:
an electronic device including a mobile application, a website, and a server having computer readable instructions readable by a processor of said electronic device;
wherein said electronic device is selected from a group consisting of a smartphone, a laptop, a PDA, and a smartwatch;
wherein said server includes a content database for storing black history content;
wherein said website provided by said server provides access to functionalities of said content database;
wherein said mobile application includes a first GUI and said website includes a second GUI;
a communication network for communication between said mobile application, said website, and said server;
wherein said black history content includes files, documents, and videos for providing educational information of said black history to registered users of said system;
a user database for storing information of said registered users of said system wherein said user database includes information selected from a group consisting of a name, a location, an age, a gender, and a profession; and
wherein said server provides a game module and a quiz module to said registered users for further providing said educational information.

2. The black history learning software application of claim 1 further comprising a registration module for managing registration and login of said registered users, wherein said registration includes security credentials of a username and password.

3. The black history learning software application of claim 2, wherein said quiz module includes quizzes using the content stored in said content database of said system, and further wherein said quiz module generates said quizzes that are pre-stored in a memory of said server.

4. The black history learning software application of claim 3, wherein said game module includes both passive and interactive games using said content stored in said content database of said system, and further wherein said game module includes rewards enabling said registered users to participate and win prizes.

5. The black history learning software application of claim 4 further comprising a recommendation module using machine learning and artificial intelligence to learn interactions of said registered users with said system, wherein said recommendation module retrieves said content and information accessed by said registered users for providing recommendations on said content and for providing recommendations on other users having similar interests.

6. The black history learning software application of claim 5, wherein said communication network is an internet.

7. The black history learning software application of claim 6 further comprising a user interface of said black history learning application for displaying customized said registered information for a logged in said registered user, wherein said registered user interface displays a categories tab for listing various types of offerings provided by said system.

8. The black history learning software application of claim 7, wherein said system further provides for said registered user to upload relevant said black history content using an upload button.

9. The black history learning software application of claim 8, wherein said system records a history of said registered user accessed content enabling said registered user to revisit said registered user accessed content.

10. The black history learning software application of claim 9, wherein said history of said system is used by a recommendation engine of said system to recommend new educational content to said registered user based on said registered user accessed content.

11. The black history learning software application of claim 10, wherein said system includes a plurality of levels that can be achieved by said registered user through learning said educational content, winning said games, and completing said quizzes.

12. The black history learning software application of claim 11, wherein said history includes said registered user identified favorite content used by said recommendation engine of said system to recommend similar educational content to said registered user based on said registered user identified favorite content.

13. The black history learning software application of claim 12, wherein said game playing includes said registered user and another user for playing a one-on-one game.

14. A method for learning black history, the method comprising:
registering a user to a computer system;
logging into said computer system;
selecting a quiz by said user, wherein said quiz includes black history content;
taking said quiz related to said black history content;
selecting and playing a game, wherein said game includes said black history content;
selecting another user for playing said game against said user; and
determining a winner of said game.

15. The method of claim 14 further comprising a step of creating a digital certificate for said winner of said game.

16. The method of claim 15 further comprising the steps of determining a loser of said game, and providing additional said black history content to said loser.

17. The method of claim 16 further comprising a step of recommending other quizzes and games to said user of said system based upon said selecting of said quiz.

18. The method of claim 17 further comprising a step of recommending other users to said user of said system based upon said selecting of said quiz.

19. The method of claim 18 further comprising another user interface for creating and attending virtual live events of said black history content.

20. A system for providing access to educational content through a black history learning software application, the system comprising:
an electronic device including a mobile application, a website, and a server having computer readable instructions readable by a processor of said electronic device;
wherein said electronic device is selected from a group consisting of a smartphone, a laptop, a PDA, and a smartwatch;
wherein said server includes a content database for storing black history content;
wherein said website provided by said server provides access to functionalities of said content database;
wherein said mobile application includes a first GUI and said website includes a second GUI;
a communication network for communication between said mobile application, said website, and said server;
wherein said black history content includes files, documents, and videos for providing educational information of said black history content to registered users of said system;
a user database for storing information of said registered users of said system, wherein said user database includes information selected from a group consisting of a name, a location, an age, a gender, and a profession;
wherein said server provides a game module and a quiz module to said registered users for further providing said educational information;
a recommendation module using machine learning and artificial intelligence to learn interactions of said registered users with said system, wherein said recommendation module retrieves said content and information accessed by said registered users for providing recommendations on said content and for providing recommendations on other users having similar interests;
a user interface of said black history learning application for displaying customized said registered information for a logged in said registered user, wherein said registered user interface displays a categories tab for listing various types of offerings provided by said system; and
wherein said system records a history of said registered user accessed content enabling said registered user to revisit said registered user accessed content.
